(19) United States
(12) Patent Application Publication
(10) Pub. No.: US 2005/0028761 A1
(43) Pub. Date: Feb. 10, 2005

(54) Interchangeable 2-stroke or 4-stroke high torque power engine

(76) Inventor: Robert Louis Giuliani, Honolulu, HI (US)

Correspondence Address: R.L. GIULIANI, 1456 THURSTON AVE. A-1204, HONOLULU, HI, 96822, US

(21) Appl. No.: 10/935,402

(22) Filed: Sep. 7, 2004

Related U.S. Application Data
(63) Continuation-in-part of application No. 10/643,274, filed on Aug. 18, 2003.
Application No. 10/643,274 is a continuation-in-part of application No. 10/252,927, filed on Sep. 24, 2002, now abandoned.

(51) Int. Cl. F02B 75/18

(52) U.S. Cl. 123/52.1; 123/197.1

(57) ABSTRACT

This is a high torque power, offset piston engine with a straight power shaft. It is interchangeable between a 2-stroke and a 4-stroke by easily repositioning an idler. Objects of this invention include: 1. easily interchanged between 2-stroke and 4-stroke; 2. instant peak torque at the beginning of the power stroke; 3. power stroke overlap; 4. piston always square in its cylinder reduces cylinder wear; 5. a rugged breakaway 1-way clutch that is easily disassembled and reassembled for repairs; 6. the 1-way clutch overrun feature allows deactivating pairs of pistons without load on the shaft; 7. lightweight piston and rod due to compression forces only; 8. low cylinder expansion rate with a small bore, which allows more complete combustion of a small combustion charge resulting in high fuel efficiency; 9. reduced mass engine compared to a crank engine.

This is a continuation-in-part of CIP Ser. No. 10/643,274 file date Aug. 18, 2003 which is a CIP of application Ser. No. 10/252,927 file date Sep. 24, 2002.

### CROSS-REFERENCE TO RELATED APPLICATIONS

Not applicable.

### FEDERALLY SPONSORED RESEARCH OR DEVELOPMENT

Not applicable.

### BACKGROUND OF THE INVENTION

Engines that transmit an offset piston's power to a straight power shaft have been attempted since at least 1921, e.g. U.S. Pat. No. 1,365,666 but have not had practical success though they inherently offer high torque and high fuel efficiency. Their weakness lies in using many energy absorbing moving parts and combustion chambers to convert the piston's reciprocating rectilinear motion to the power shaft's unidirectional rotary motion which has made them inefficient and impractical, e.g. U.S. Pat. Nos. 2,239,663; and 5,673,665. For this reason, the simple, exhaust polluting, inefficient but reliable crank engine survives as the search for a better power source continues.

Enormous funds and research have been poured into fuel cells, electric vehicles and crank engine hybrids for years in an unsuccessful effort to replace the ubiquitous crank engine.

The crank engine is very inefficient because the two angles at both ends of the connecting rod of length L and the crank angle α (FIG. 14) combine to slow the piston's speed, which traps the very rapidly expanding combustion gases in a small chamber. The gases build up very high heat and pressure at and near tdc. Here, nearly all the force from the pressure is vectored against the crankshaft's bearings instead of rotating it. Parts inertia is combined with extra fuel on each power stroke to overcome the angles' resistance. The result is excess exhaust pollution and waste heat. The waste heat is lost and the pollutants are partly scrubbed from the exhaust when it is too late.

The pollution and the waste heat must be reduced in the combustion chamber by converting them to mechanical motion with a more complete burn. To do that, all the rod and crank angles must be zero during the entire power stroke but that is impossible in a crank engine. The following mathematics explain why:

FIG. 14 is a schematic that represents a crank engine. FV1, FV2, FV3 are force vectors that come from burn pressure driving the piston 38. FV1 is along a radial of the crankshaft axis C. Only FV3, being tangent to the crank circle d, rotates the shaft where FV3=FV1(Cos θ)(Cos Φ). The crank engine's efficiency is zero at tdc when angle θ=0° but angle Φ=90°, making FV3=FV1(1)(0)=0. When FV2 is tangent to circle d. Cos Φ=1.0 and Tan θ=r/L and θ=Tan⁻¹r/L from which Cos θ is found. The efficiency at that point is FV3/FV1=Cos θ. The importance of angle θ=Tan⁻¹r/L will be shown below.

The ratio of the displacement M along the crank circle d to the piston's displacement a at any chosen crank angle α is easily found from FIG. 14. r is the crank arm length and α is in degrees:
r=b+a
a=r(1−Cos α)
M=παr/180
M/a=πα/[180(1−Cos α)]
For instance, when α=10°, M/a=11.49:1. At this point, the rod's slow crank end must go 11.49 times as far as the piston. The slower the crank's rotation, the longer the gases are trapped in a small chamber and the lower the engine's efficiency. It is known that this is where the confined hot, pressurized gases create most of the pollution and waste heat. The crank's angular efficiency:
Cos θ=FV2/FV1
Cos Φ=FV3/FV2
FV2=FV1(Cos θ)
FV2=FV3/Cos Φ
FV3=FV1(Cos θ)(Cos Φ)
FV3/FV1=(Cos θ)(Cos Φ) Crank engine's angular efficiency. It caps thermal efficiency.

FIG. 14 is also the basis for the following indented equations that lead to the Cos θ and Cos Φ equations in terms of crank angle α, length L and crank arm r:
180−β=γ
γ+θ+Φ=180
β=90−α Note the rt. triangle (α+β+90)
180−(90−α)=γ or 90+α=γ
(90+α)+θ+Φ=180
α+θ+Φ=90
n=r Sin α
Sin θ=(r/L)Sin α
θ=Sin⁻¹[(r/L)Sin α]
Cos θ=Cos{Sin⁻¹[(r/L)Sin α]}
α+Sin⁻¹[(r/L)Sin α]+Φ=90
Φ=90−{α+Sin⁻¹[(r/L)Sin α]}
Cos Φ=Cos(90−{α+Sin⁻¹[(r/L)Sin α]}
The equations Cos θ, Cos Φ are easily solved with a hand calculator. For instance, they give the angular efficiency=22.4% when α=10°; r=1.5″; L=5.0″. Since the thermal efficiency is low (See M/a above) the total efficiency has to be much less than 22.4% in this example. The efficiency increases as a increases but the combustion pressure decreases as a increases. A higher rpm increases efficiency but that has reached its limit and it is not good enough.

The importance of angle θ=Tan⁻¹r/L now follows. That is when FV2 is tangent to the circle d at the arm r which makes angle Φ=0.0 and Cos Φ=1.0. The angular efficiency is Cos θ=Cos(Tan⁻¹r/L). In the example above where r=1.5″ L=5.0″; FV3/FV1=Cos θ=95.8%. Extend L relative to r so that angle θ goes to 0.0. Then

$${Lim}_{θ -> 0.0} Cos θ = 1.0 .$$

(This is the foundation for calculus). That makes the angular efficiency FV3/FV1=(Cos θ)(Cos Φ)=(1)(1)=100% because there is no angular resistance since the angles θ,Φ disappear. The variable angle α disappears. The crank arm r disappears. The variable length torque arm n (FIG. 14) which requires torque buildup is replaced by the fixed length torque arm r′ (FIG. 15) which gives instant peak torque.

Unlike the crank, FV1 in this invention (FIG. 15) is always directed to rotating the output shaft 8 rather than directed against the shaft's bearings. FV1 is transmitted with both angles θ,Φ=0.0 through the entire power stroke. The M/a=1:1 through the entire stroke. The circumference d′ replaces the crank circle d in FIG. 14. Motion is transmitted through the fixed length torque arm r′ to the output shaft 8.

### BRIEF SUMMARY OF THE INVENTION

This is a high torque power, fuel-efficient engine that can be easily switched between a 2-stroke and a 4-stroke. A pair of combustion cylinders and their related pairs of parts, including 1-way clutches, are connected by an idler gear to make the basic 2-stroke engine. A third idler connects two pairs to make a 4-stroke engine. Computer controlled ignition allows power stroke overlap by equally spaced-apart pistons. The crankshaft is replaced by a straight power shaft.

A rugged 1-way clutch transmits motion between the power piston and the output shaft. The piston is offset from the shaft's axis by the radius of the 1-way clutch at the point where it engages the piston connecting rod. Conventional 1-way clutches are unsuitable. They are inefficient because they transmit motion between the races through two vectors. One vector is parallel to the clutch radial which does not transmit motion. Instead, its energy is converted to waste heat that can contribute to early clutch failure. A preferred 1-way clutch that efficiently transmits torque between its races perpendicular to a clutch radial is described below with reference to FIGS. 7-13.

The math below can be used to calculate important values in designing a 2-stroke and a 4-stroke.

Objects of this invention include:
1. easily interchanged between 2-stroke and 4-stroke;
2. low cylinder expansion rate with a small bore, which allows more complete combustion of a small combustion charge resulting in high fuel efficiency;
3. instant peak torque at the beginning of the power stroke;
4. the 1-way clutch overrun feature allows deactivating pairs of pistons without load on the shaft;
5. reduced mass engine compared to a crank engine;
6. a rugged breakaway 1-way clutch that is easily disassembled and reassembled for repairs;
7. lightweight piston and rod due to compression forces only;
8. piston always square in its cylinder reduces cylinder wear;
9. power stroke overlap.

### BRIEF DESCRIPTION OF THE DRAWINGS

In the drawings:

Number 42 in FIGS. 1-3 reference arrows that show motion and direction of several key parts for an easier and quicker general understanding of this invention. The motion and direction of the same and other parts are presumed obvious in FIGS. 4-13 and shown only with arrows there.

FIGS. 2,3 show a representative 1-way clutch of any suitable design but a preferred rugged design in which motion is transmitted between races perpendicular to clutch radials is described with reference to FIGS. 7-13. Number 89 refers to a cover plate in FIGS. 10,13 and to a cover plate with cartridge, including its elements in FIGS. 7,8. The outer race is referred to by its separate parts 5A, 5B and 5C in FIGS. 7,8 and as a whole by the number 5 in the other FIGs. Number 82 and number 96 in FIGS. 7,8 refer to equivalent parts. The output shaft is represented by its axis 91 in FIG. 8. Parts are shown with solid lines in drive and dashed lines in overrun.

FIG. 1 is a side view showing how movement of parts is synchronized between a pair of pistons.

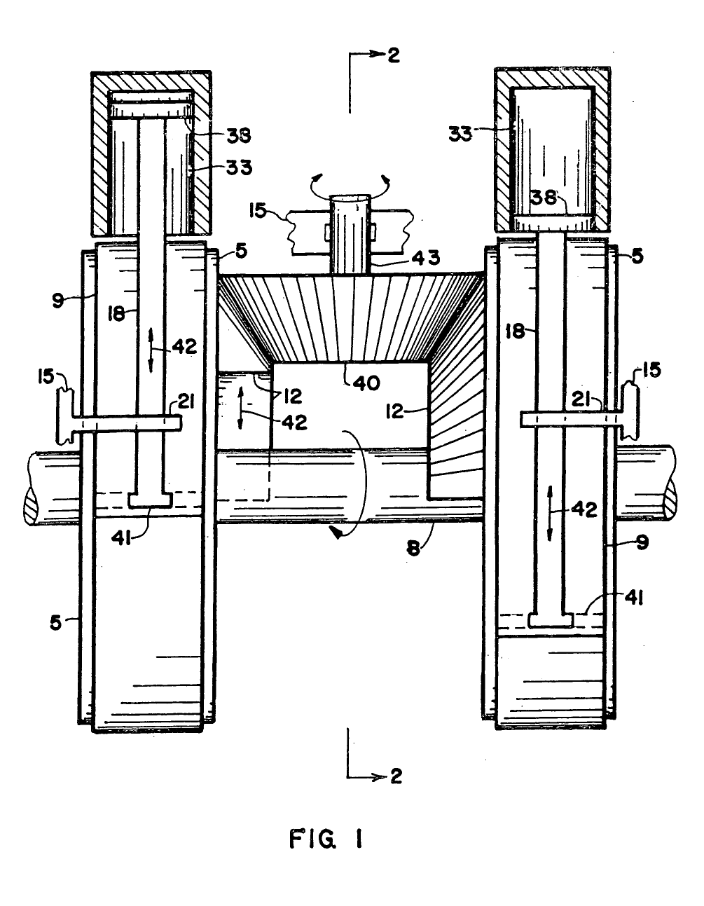

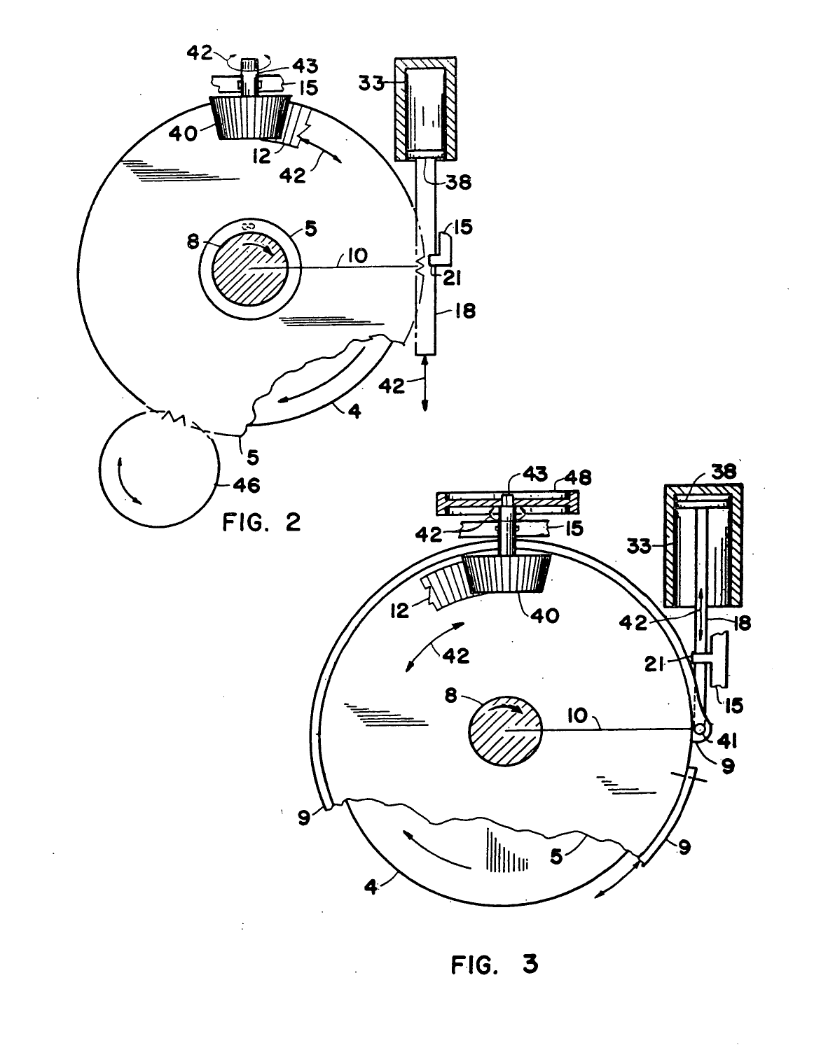

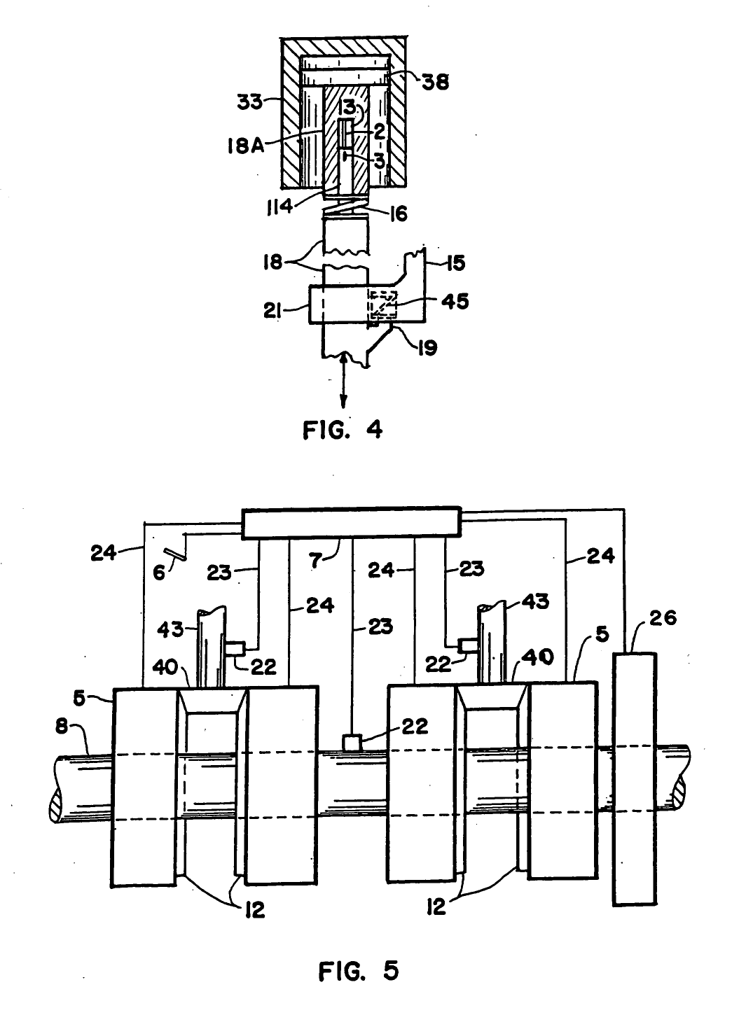

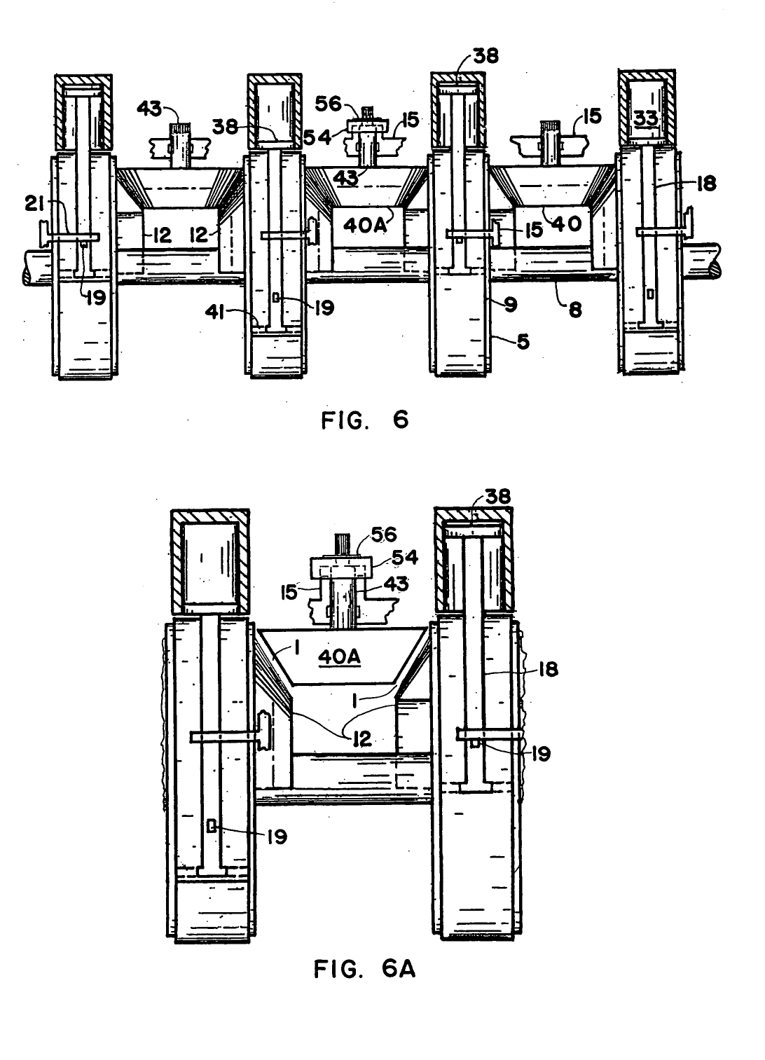

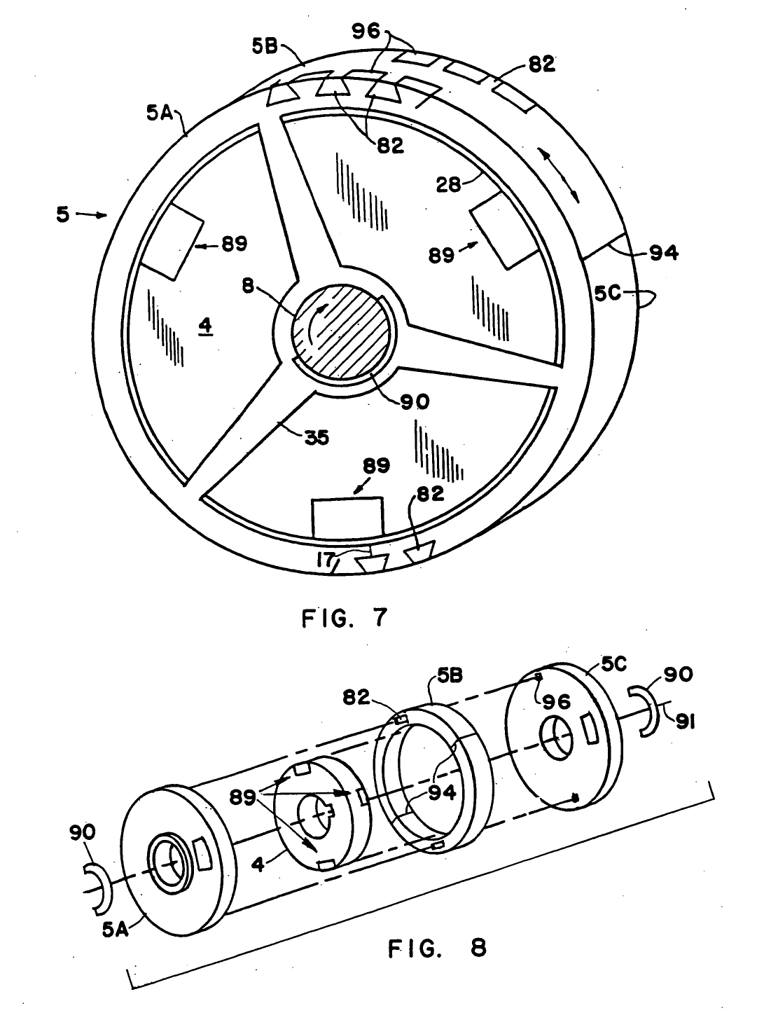

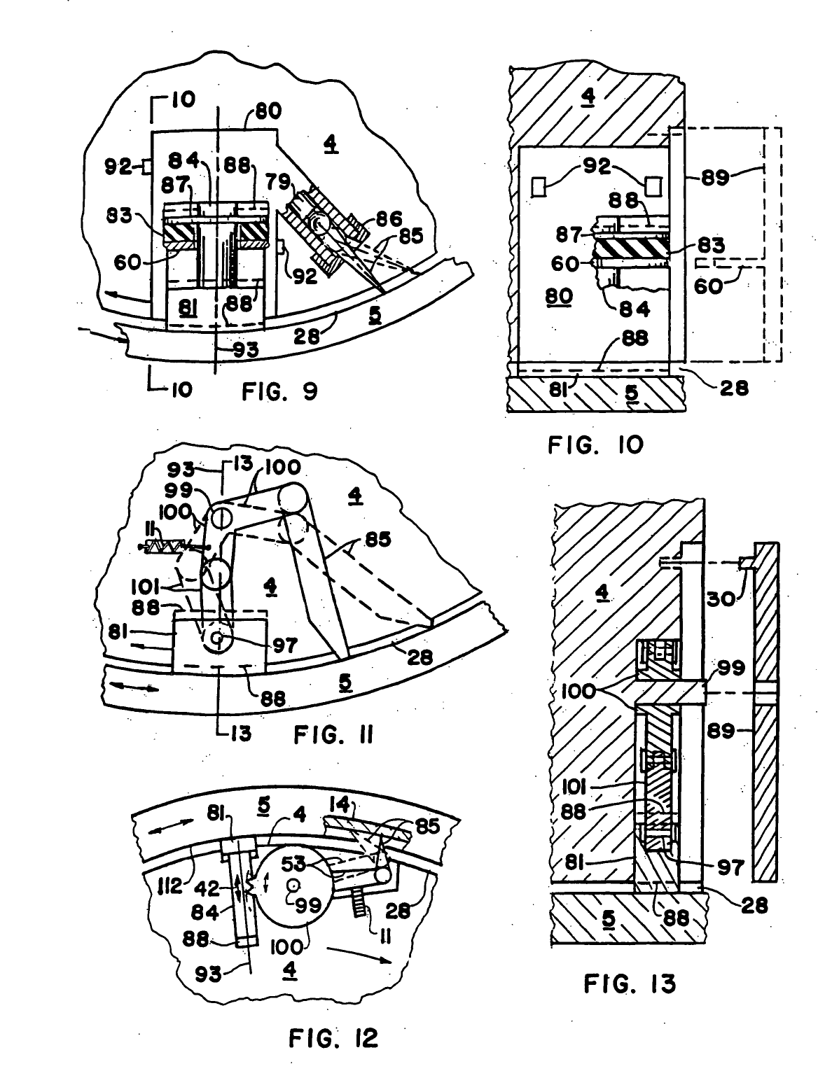

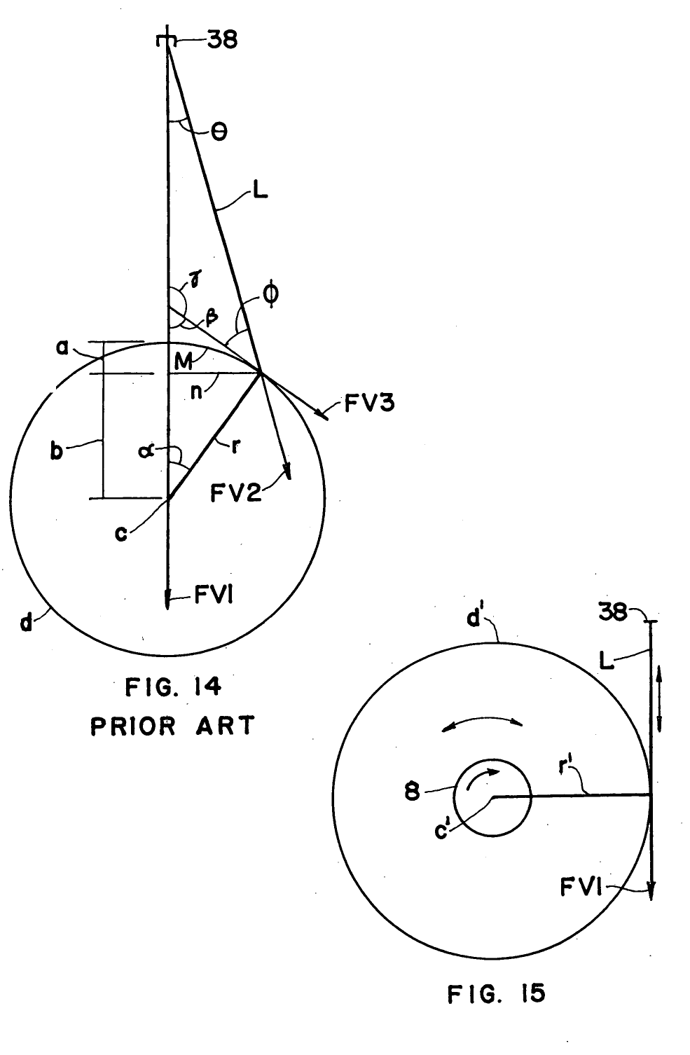

FIG. 2 is taken essentially along line 2-2 in FIG. 1 to show how motion is transmitted between a piston and a 1-way clutch through a gear mesh.

FIG. 3 shows how a belt or a chain replaces the gear mesh in FIG. 2.

FIG. 4 shows a means for decelerating and reversing pistons at the end of the stroke.

FIG. 5 shows two computer controlled pairs of cylinders combined with an energy storage device.

FIG. 6 shows a 4-stroke engine by combining two pairs with a third idler 40A.

FIG. 6A focuses on separation of idler 40A from the sector gears in FIG. 6 to create a 2-Stroke.

FIG. 7 shows an oblique view of the 1-way clutch with keystone shaped interlocking teeth on the outer race.

FIG. 8 is an exploded view of the several parts of the FIG. 7 clutch aligned along a shaft axis.

Alternatively, pegs with matching holes replace the teeth in FIG. 7.

FIG. 9 is a side view of a replaceable clutch cartridge with its cover plate removed and casing broken away to show the internal elements of a hydraulic motion transmitting member.

FIG. 10 is a cross sectional along 10-10 in FIG. 9.

FIG. 11 is one embodiment of a mechanical transmitting member.

FIG. 12 is a second mechanical embodiment of a transmitting member.

FIG. 13 shows a cross sectional along 13-13 in FIG. 11.

FIG. 14 is a schematic of a crank engine used for mathematical reference in the text above.

FIG. 15 is a schematic of this invention used to mathematically compare with FIG. 14.

### DETAILED DESCRIPTION OF THE INVENTION

First, consider the benefit of overlapping power pistons on the power stroke e.g., a 2-stroke, 6 cyl engine with a 9″ piston stroke would simultaneously have the 1^{st} piston 6″ after tdc, the 2^{nd} piston 3″ after tdc and the 3^{rd} piston igniting at tdc. The 6 pistons continuously cycle through their power strokes in this sequence. The power added by the 3^{rd} piston is reduced by the combined remaining power of the 1^{st} and 2^{nd} pistons resulting in fuel savings and smooth power shaft rotation.

Underlying Mathematics.

Defintions:

1 BTU=778 ft-lbf
1 hp=550 ft-lbf/sec.
2πr′=length of 1-way clutch rim at connecting rod contact. (ft)
bore—cylinder diameter. (in.)
Cp—cylinder pressure calculated from known bore size. (psi)
Dp—displacement (cu.in.)
E—fuel efficiency
F—combustion force per piston. (Ibf)
Fg—fuel flow rate (gals/hr)
Fi—shear force on the inner race (lbf)
Fr—fuel flow rate (Ibm/sec)
Fu—shear force per unit 89 (lbf) See FIG. 7 or FIG. 8 for unit 89.
Fw—fuel's weight (Ibm/gal.)
hp—shaft horsepower.
k=2 or 4 (k=2 for a 2-stroke. k=4 for a 4-stroke.)
Lo—fraction of power lost to the engine.
n—number of active pistons. 2,4,6,8, . . .
n/k—number of overlapping pistons cycling through the power stroke.
Nu—number of units 89 (FIGS. 7,8).
Pp—combustion pressure per piston. (psi) Used to find the bore size. (in.)
Ps—length of piston's stroke. (in.)
Qc—fuel's energy density. (BTU/Ibm)
   r—radius of cylinder. (in)
   r′—1-way clutch radius at connecting rod contact. (ft)
   ri—radius of the 1-way clutch inner race. (ft)
   Rv—power shaft's rotation rate. (rpm)
   Sp—Center to center spacing between units 89 (FIGS. 7,8). (ft)
   T—torque per piston. (lbf-ft)
   T′—total shaft torque. (lbf-ft)
   Vp—piston velocity. (ft/sec)
      Equations:
      Vp=π(r′)(Rv)/(30) Piston rod and the 1-way clutch rim speed are equal at contact.
      r′=30(Vp)/π(Rv) r′,Vp,Rv are central to this engine's design and operation.
      Rv=30(Vp)/(πr′)
      F=550 hp(k)/(nVp)
      hp=F(n)(Vp)/550
      hp=Fr[778(Qc)(1−Lo)]/550
      T=F(r′)
      T′=nT/k
      Pp=F/[π(r²)]
      r²=F/(πPp)
      bore=2[F/(πPp)]^{0.5}
      F=π(Pp)(bore²)/4
      Fi=F(r′)/ri
      Nu=2π(ri)/Sp
      Fu=F(r′)(Sp)/[2π(ri²)]
      Fu=F(r′)/[(ri)(Nu)]
      Fu=Fi/Nu
      Cp=4F/(πbore²)
      Dp=π(bore/2)²(Ps)(n)
      Fr=550 hp/[778(Qc)(1−Lo)]
      Lo=1−550 hp/778(Qc)Fr
      E=1−Lo
      E=550 hp/778(Qc)Fr
      Fg=Fr(3600)/(Fw)

The following example demonstrates the effectiveness of the Underlying Mathematics in finding the correct general engine specifications from which the rest of the engine can be built. The given values are hypothetical in this example. This example is for a low power engine, e.g. lawn mowers and outboard marine, but the math can be applied to any size engine.

### EXAMPLE

Given: Pp=100 psi; F=300 lbf; Vp=3.5 ft/sec; r′=4.5″=0.375 ft; ri=3.75″=0.3125 ft;

k=2; n=2; Qc=20500; Lo=0.35; Fw=6 lbm/gal; Sp=6″=0.5 ft
   hp=300(2)(3.5)/[2(550)]=1.909
   r²=300/(100π)=0.9549 in²
   bore=2[300/(100π)]^{0.5}=1.9544 in.
   Rv=30(3.5)/(0.375π)=89.13 rpm
   Fi=300(4.5)/3.8=355.37 lbf
   Nu=2π(3.8)/6=4
   Fu=300(4.5)/[6(3.75)]=60 lbf.
   T=300(0.375)=112.5 lbf-ft
   Fr=550(1.909)/[778(20500)(1−0.35)]=0.000101284 lbm/sec.
   Fg=0.000101284(3600)/6=0.060770629 gals/hr.
   Given: hp=10; F=380 lbf.
   Vp=550(10)(2)/2)(380)=14.5 ft/sec.
   Rv=30(14.5)/(0.375 π)=369 rpm.
   Fi=380(4.5)/3.8=450 lbf
   Fu=380(4.5)/[6(3.75)]=113 lbf.
   Cp=4(380)/[(1.9544²)π]=126.67 psi.
   T=380(0.375)=142.5 lbf-ft
   Fr=550(10)/[778(20500)(1−0.35)]=0.000530537 lbm/sec.
   Fg=0.000530537(3600)/6=0.318322345 gals/hr.
   Discussion.

A pair of combustion cylinders 33 and related pairs of parts that include a pair of 1-way clutches (FIGS. 1-3) make the basic 2-stroke engine in this invention. The clutch's inner race 4 is keyed to the power shaft 8. The outer race 5 carries a sector gear 12. Each gear 12 engages an opposite side of idler 40 whereby synchronous reverse motion is transmitted between the power piston 38 and the second piston 38 in the pair as the inner race 4 transmits the power to the shaft 8.

Combining two pairs with idler 40A creates a 4-stroke shown in FIG. 6 that will be described below under Interchanging 4-stroke and 2-stroke.

One end of a V-belt or a chain 9 is fastened to the outer race 5 (FIGS. 1,3). The way it is wrapped around race 5 always keeps it taut, which prevents backlash as it rotates race 5 in response to the power stroke. Rod 18 is connected to the other end of the belt or chain 9 with a suitable fastener 41.

The 1-way clutch's override feature in this engine allows output shaft 8 and the clutch's inner race 4 to rotate independently of the pistons 38 when the inner race's speed is greater than the outer race 5 speed. This feature creates regenerated energy that is collectable in an energy storage device 26 (FIG. 5) available, e.g. for dumping to shaft 8 on demand or generating electricity.

The fixed length torque arm 10 (FIGS. 2,3) causes instant peak torque at the beginning of the power stroke. A connecting rod guide 21, secured to housing 15, eliminates side thrust and reduces wear by keeping the piston 38 square in its cylinder. Wrist pins and piston skirts are not needed. The guide 21 is combined with a decelerator mechanism (FIG. 4) to stop piston 38 at or near top dead center. The decelerator includes a node 19 that is part of each rod 18 in a pair and a spring 45 for each node. The spring is encased in the guide 21. An opening in the housing 15 allows easy replacement of the spring. The spring absorbs the impact of node 19 to halt the motion of piston 38, which is then accelerated on its power stroke by timely expanding combustion gases. The impact is reduced because node 19 is decelerating due to the power loss of the power piston to the shaft 8. The decelerator is positioned to prevent backlash of the gears 12 (FIGS. 1,6) that mesh with idler 40.

A computer 7 (FIG. 5) monitors input from the throttle 6 and shaft power from the sensor 22 on shaft 8 through leads 23 to determine the size of the combustion charge to transmit to the cylinders through injector lines 24. The position of piston 38 is monitored through sensors 22 on shaft 43 and used for ignition timing. By monitoring the motion of each shaft 43 in several pairs, the computer controls timing between the unconnected pairs in a 2-stroke embodiment. The computer begins a power stroke with a piston in one pair when a piston in another pair is partly through its power stroke. In a 2-stroke, 50% power stroke overlap and smooth rotation of the shaft 8 is had with two unconnected pairs (four cylinders). Greater overlap is gained with more pairs.

Moderated Combustion Pressure.

The extreme pressure and heat at and near tdc in crank engines cause energy laden, unburned fuel in bypass gases that only dirty the crankcase oil and require frequent oil changes. This inefficiency can be avoided in this engine.

Rather than a large bore that allows an excessive expansion rate, a small bore with a long stroke can be used with a lower expansion rate by controlling the peak pressure on the piston. The Underlying Mathematics above can be used to approximate the best cylinder size and the engine computer 7 (FIG. 5) can dynamically adjust the size of the fuel charge but there is a further need to dynamically adjust the combustion's expansion rate to maintain the fuel's best burn pressure within a narrow range especially under high or variable loading, e.g. large marine engines, and trucks. This section describes three ways to that end by absorbing excessive peak pressure and dispensing it back into the chamber 33.

The first way replaces the straight piston rod (FIGS. 2,3) with a two-part piston rod 18 and 1 8A having a spring 16 between them (FIG. 4). Spring 16 is connected to the two parts such that its compression and expansion are not affected. Rod part 18 has an extension 114 that extends through the center of spring 16 into a cylinder 13 in part 18A (shown in cross section) to keep the spring 16 centered on the axis of the two piston parts. Significant side thrust on the parts is not likely because the piston 18 is square in cylinder 33 and combined with guide 21 to absorb excessive peak cylinder pressure and dispense it back to the There are two channels 2 on opposite sides of the cylinder 13 that are aligned with the axis of the cylinder. A small projection 3 on extension 14 reaches into each channel to prevent angular motion of part 18A and piston 38.

A second way includes a small, suitable flywheel 48 splined to the end of shaft 43 (FIG. 3). A conventional flywheel can be used but an alternative comprises three concentric parts. The inner part is splined to shaft 43. The outer part extends to the flywheel's rim. Between them is a tough, slightly elastic part that absorbs some of the initial ignition jolt.

A third way is to construct the inner race 4 with springs like the flywheel carried behind the engine of conventional vehicles. The inner race performs like the flywheel.

Interchanging 4-Stroke and 2-Stroke.

FIG. 2 shows a rack and pinion gear to transmit the piston power between the rod 18 and the outer race race 5 of the 1-way clutch. The rod 18 reciprocates along a straight path 42. The rack and pinion is best suited as an interchangeable 4-stroke and 2-stroke for use in small engines. By shifting race 5, the starter 46 shifts both pistons 38 until ignition. Alternatively, shaft 43 can be used to shift the pistons until ignition. The 4-stroke version in FIG. 6 needs one starter 46 (not shown).

Another configuration that allows interchanging between a 4-stroke and 2-stroke engine is described here. In FIG. 3, the flexible chain 9 must be made stiff enough to pull the piston 38 down during the intake stroke in the 4-stroke engine. In this case, the outer race 5 is a cogwheel and the cogs fit between the chain links similar to a bicycle chain. Each side of each link has an extension that rides in an immovable channel that is secured to the engine. The two channels combine with the side extensions to prevent the chain from flexing out of mesh with the race 5 cogwheel during the intake stroke and without interfering with the other piston strokes. Both channels are shaped in an arc around the race 5 where they are connected with a solid cover over the chain to insure against the chain flexing. The cover ends near the position of fastener 41 in FIG. 3 when piston 38 is at top dead center. The channels continue straight downward without the cover to prevent the chain from flexing when it is straight. The straight channels extend to a point slightly beyond the position of fastener 41 when the piston is at bottom dead center. The fastener is connected to the chain free of the extensions so that the channels do not interfere with the motion of the chain. This allows the fastener 41 to reach its highest point (FIG. 3) where it is in position to begin the intake stroke and complete the stroke without interference from the channels or the cover. The chain extends far enough around cogwheel race 5 so that a few cogs remain in their links to allow the other links to separate and rejoin their respective cogs without wear.

There are at least two simple ways to change between a 2-stroke and a 4-stroke. In a 4-stroke, a sector gear 12 on each of two pairs engages idler 40A (FIG. 6). A removable cap 54 having a hole is threaded to the engine 15. The shaft 43 of idler 40A has two diameters. The shorter one extends through the hole. A snap ring 56 on the shorter diameter abuts the cap and combines with the larger diameter that abuts the inside of the cap to prevent the idler 40A from axial movement which keeps the idler properly engaged with the two sector gears. When changing to a 4-stroke from a 2-stroke, the pistons must be correctly positioned before engaging the idler with the sector gears. One of the correct positions is shown in FIG. 6 with 2 pistons at top dead center and 2 at bottom dead center. Power stroke overlap for a 4-stroke can be achieved by adding another bank of two pairs along the shaft 8 disengaged from the bank shown in FIG. 6 or by adding separate pairs.

The separation 1 in FIG. 6A makes the 4-stroke a 2-stroke. To change to a 2-stroke from a 4-stroke, the cap 54 is partly unscrewed to a predetermined position on the engine 15, which raises shaft 43 and disengages idler 40A from sector gears 12 (FIG. 6A). The cap is held in place by known means, e.g. a dowel through the side of the cap that contacts engine 15.

Hydrogen Enhanced Ignition.

In some applications, considerable regenerated energy from shaft 8 is anticipated from the 1-way clutch's overrun feature. The device 26 (FIG. 5) includes a means (not shown) to convert the energy to hydrogen (H₂) and a temporary H₂ storage tank. A minimum of the H₂ is injected into the combustion chamber with the primary fuel.

Hydrogen's “flame speed” in an H₂ rich mixture is about 6 times faster than gasoline. (Energy Technology HDBK, pp. 4-39 to 443, Considine, 1977). The high compression pressure creates a rich H₂ mixture. High heat from the ignited H₂ saturates the primary fuel to cause a more complete bum of the primary fuel's droplets, which increases fuel efficiency. The high, prolonged pressures that cause NOx will be greatly reduced if Vp and r′ are selected to allow a fast piston acceleration to reduce the pressure. If needed, flywheel 48 fine adjusts the acceleration and pressure for the best burn.

M/a=1:1 (See M/a above) and the angles θ, Φ, α (FIG. 14) do not exist.

Parabolic Reflector Cylinder Head.

A drawing is believed not necessary to describe this embodiment. The entire cylinder head is a parabolic reflector with an igniter at its focus. The focus is at the end of a replaceable plug. An energy wave expands from the igniter to hit the parabolic reflector and the reflector directs the energy wave to uniformly impact the flat piston crown when it is at or near top dead center. Both pistons in a pair will be decelerating due to power bleed and the additional wave energy will help to reverse and accelerate both pistons 38 from zero where it is most effective in saving fuel.

Preferred 1-Way Clutch Embodiment

The preferred breakaway 1-way clutch is shown in FIGS. 7-13. Its outer race 5 drives clockwise in its indexing motion. The outer race 5 has three separate parts: sides 5A, 5C and race 5B. Race 5B is the outer rim of the gap 28 (FIGS. 7,9-11,13). The gap is narrow and near the race 5B to reduce stress on the parts. FIG. 7 shows the torque transmitting units 89 in relation to the gap. Keystone shaped teeth 82 (FIG. 7) extend from race 5B and make a strong interlocking fit with keystone shaped teeth 96 on the sides 5A and 5C The fit locks the parts together radially and circumferentially but allows them to be easily moved axially for disassembly by removing the snap rings 90 (FIG. 8). FIG. 8 shows equivalent pegs 82 that fit into holes 96 in sides 5A and 5C. There are as many teeth or equivalent pegs as needed.

The inner race 4 is keyed to power shaft 8. A snap ring 90 carried by shaft 8 on each side of the race 5 (FIG. 8) keeps the clutch from shifting along the axis 91 of shaft 8. The snap rings also prevent separation of the three outer race parts. In extreme or unusual use, a dowel 17 (FIGS. 7) reinforces the snap rings to keep the parts together. It extends through race 5A and 5C to contact a keystone shaped tooth 82 (or an equivalent peg 82 in FIG. 8) on each side of race 5B. It is easily displaced for breakaway to replace race 5B.

FIGS. 7,8 show two halves of race 5B that are kept in contact 94 by the teeth (or pegs). When race 5B is separated from sides 5A and 5C, the halves fall apart for replacement without separating the other parts from shaft 8.

Bearings in FIG. 7 are between the outer race 5 and the shaft 8. Spokes 35 in side 5A and side 5C reduce material cost and reduce indexing inertia. The transmitting units 89 are easily replaceable when positioned between the spokes or behind an aperture in the sides 5A and 5C.

Move the bearings to the conventional position at gap 28 and the dowel (FIG. 7) can keep the parts together without the spokes 35.

The cover plate 89 (FIGS. 12,15) is designed to guide the moving parts during their movements.

Hydraulic Embodiment of the 1-Way Clutch.

Replaceable hydraulic cartridges 89 (FIGS. 7,8) are carried by race 4. The race is molded to rigidly hold the cartridge casing 80. Pegs 92 (FIG. 9) slide into grooves in the race 4 to reinforce the cartridge against movement, especially toward race 5 under centrifugal force. A unit piston 81, shown in driving contact with race 5 (FIGS. 9,10), moves a short distance 88 along the clutch radial 93 (FIG. 9) while in sliding contact with the casing 80 and the casing is in contact with race 4. The piston 81 is secured to a piston rod 84 (FIGS. 9,10) that is hydraulically actuated from a reservoir section of the casing from which it extends. Torque between race 5 and race 4 is transmitted through the piston perpendicular to radial 93 that extends from the axis 91 (FIG. 8) of shaft 8. The casing 80 has an arm that holds a plunger 79 in contact with the ball end of a trigger 85. A cap 86 having a slot aligned with the trigger's motion is immovably secured to the arm. The trigger extends through the slot to contact the race 5. A resilient piece inside the cap between it and the ball end is preferred. The angle between the arm and the radial is small to prevent jamming between the arm and the trigger.

As the trigger 85 shifts from its overrun position to the drive position, it pushes the plunger 79 farther into its arm to displace hydraulic fluid in the reservoir contained in the casing 80. The fluid displaces the piston rod 84 to drive the piston 81 into non-slip contact with race 5. The piston is in contact with race 4 and drive is transmitted from race 5 through the piston to race 4 perpendicular to a clutch radial. One contact surface of the piston or race 5 should have a V-groove and the other shaped to increase non-slip friction upon contact. The trigger's motion is unhindered as it moves the piston from the overrun position 88 to contact the race 5, except for compressing a resilient element 83 (FIGS. 9,10).

The two-part resilient element 83 fits around the rod 84 for easy replacement. The element is positioned between a plate 87 that is part of the rod and a two-part, immovable second plate 60 that is part of the casing 80 and cover plate 89. When the trigger shifts to its drive position, the element is compressed between the two plates as the hydraulic fluid drives the rod 84 to bring the piston and race 5 into non-slip contact. The element expands against the immovable plate 60 to shift the piston to its overrun position 88 when the trigger shifts to its overrun position and releases the fluid pressure.

Mechanical Embodiments of the 1-Way Clutch.

Two of at least three mechanical versions of the transmitting units are shown in FIGS. 11,12. A casing for them is omitted to show a cost saving but can be included. The cover plate 89 and race 4 substitute for the casing 80. Without a casing, the piston 81 is always in direct, sliding contact with race 4 as it reciprocates along the radial 93 that extends from the clutch axis 91 (FIG. 8). Like the hydraulic version, the short reciprocal motion goes between contact with the race 5 and position 88. Drive is transmitted perpendicular to the radial 93 from race 5 through the piston to race 4.

FIG. 11 shows the piston connected to a piston rod 101 by a wrist pin 97. The rod is connected to a lever 100 which, in turn, is connected to the trigger 85. All the connections are hinged to allow pivoting. The lever's fulcrum 99 extends from race 4. A cantilevered fulcrum (not shown) uses a snap ring or common washer and cotter pin to retain the lever. But a stronger fulcrum fits into a hole in the plate 89 (FIG. 13) which is preferred for heavy duty. Three pegs 30, placed at the apexes of a broad triangle on plate 89, rigidly fix the plate to the race 4 in all embodiments. The angle between the lever 100 and the trigger 85 equals or is very close to 90° in the drive position to reduce stress on the trigger and its connection with the lever. The angle between the rod 101 and lever is preferably not straight when the piston contacts race 5. After contact, the angle straightens to increase pressure between the piston, the race 5 and lever's fulcrum 99 with limited force upon the trigger. A spring 11 insures instant separation of the piston 81 from race S as overrun begins.

The second mechanical version is shown in FIG. 12. Some reference numbers for the same parts in FIG. 11 are omitted in FIG. 12 to avoid overcrowding. A lever 100 oscillates on its fulcrum 99 which extends from race 4. As is in FIG. 11, the lever is actuated by spring 111 to separate piston 81 and race 5. A gear mesh combines lever 100 with rod 84 to shift piston 81 into and out of contact with surface 112 on race 5. The piston is shown in contact with surface 112. The single piece rod 84 and piston 81 shift along a clutch radial 93 while in sliding contact with the carrying race 4. Space 88 allows the shift. Only a few teeth complete the gear mesh since the rod's motion is very short. A very short motion makes backlash negligible so that the gear mesh could be eliminated in favor of a single piece lever and rod. The spring-loaded trigger 85 at the end of arm 53 extends across gap 28 and stays in contact with the tough, long wearing strip 14 carried by race 5. The piston does not contact the strip 14. The trigger slides over strip 14 during overrun and grabs it at the beginning of the power stroke to oscillate the lever in response to the motion of race 5, thereby shifting the rod and piston. Torque is thus efficiently transmitted to race 4 perpendicular to the clutch radial 93.

Not shown is a third mechanical version that sets the piston on one radial of the clutch and the fulcrum on another. It can also eliminate the rod 101.

In all the 1-way clutch embodiments shown in FIGS. 9-13 one of the contact surfaces has a common V-groove and the other contact surface is beveled to fit it to prevent slip. The trigger dynamically adjusts the pressure between the piston and race 5.

1. An engine comprising:
a pair of work members each including a 1-way clutch further comprising an outer race and an inner race, a combustion cylinder, a piston for reciprocating in said cylinder, a piston rod connected to the piston and transmitting power to a periphery of the outer race by a first means;
each inner race secured on a power output shaft;
an idler gear located between and driven by the outer races so that the outer races maintain synchronous motion between the two out of phase pistons as the inner races transmit the power to the shaft.

2. The engine of claim 1 in which said first means comprises a rack gear on the end of said rod, said outer race periphery having a pinion gear engaging said rack gear, and a guide maintaining alignment between the rack and gear.

3. The engine of claim 1 wherein said first means comprises a belt or equivalent chain secured to the end of said rod and said periphery and a guide maintaining alignment between them.

4. The engine of claim 1 further comprising a spring contacting a node on said rods when the pistons near top dead center.

5. The engine of claim 1 further comprising a cylinder head shaped like a parabolic reflector, an igniter at the focus of the reflector, the piston having a flat crown facing the reflector.

6. The engine of claim 1 further comprising means for delivering a primary fuel and minimal amount of a secondary fuel, the secondary fuel being hydrogen and having a flame speed greater than the primary fuel.

7. The engine of claim 1 comprising a spring-loaded two-part piston rod or equivalent spring-loaded inner race wherein combustion pressure in said combustion cylinder is moderated.

8. The engine of claim 1 comprising a flywheel wherein the flywheel moderates combustion pressure in said combustion cylinder.

9. The engine of claim 1 which includes more than one independent pairs of the work members and the pistons cycle spaced apart through power stroke overlap.

10. The engine of claim 1 which includes more than one independent pairs of work members and means for selectively activating and deactivating the pairs.

11. The engine of claim 1 being interchangeable between a 2-stroke and a 4-stroke which includes, an independent pair disposed along the shaft that comprise a 2-stroke, an idler engaging two independent pairs effects a 4-stroke engine, a disengagement of the idler reverts back to a 2-stroke engine and engaging reverts again to a 4-stroke.

12. A 1-way clutch comprising;
a first race and a second race,
a torque transmitting unit, and
the transmitting unit carried by the first race wherein the transmitting unit transmits torque between the races perpendicular to a radial of the 1-way clutch.

13. The 1-way clutch of claim 12 comprising;
a first contact surface on the second race and a radially shiftable contact surface carried by the transmitting unit, the first contact surface having a V-groove and the said shiftable contact surface beveled to fit the V-groove wherein non-slip contact is increased.

14. The 1-way clutch of claim 12 in which the said torque transmitting unit includes;
a radially shiftable unit piston, a hydraulic element, a trigger, a resilient member; and
the said trigger providing communication between the said second race and the hydraulic element wherein a first direction change in the second race actuates the hydraulic element to engage the said unit piston with the second race thereby compressing the resilient member whereby the unit piston transmits the said torque and a change to a second direction actuates the resilient member to disengage said unit piston whereby the torque transmission is prevented.

15. The 1-way clutch of claim 12 in which the torque transmitting unit comprises a lever having a spring-load, a trigger, a radially shiftable unit piston, said lever communicating with the unit piston, the said trigger communicating with the lever and the said second race wherein a first direction change causes the trigger to actuate the lever to engage the unit piston with the second race thereby transmitting the said torque and a change to a second direction actuates the spring-load to reverse the lever which disengages the said unit piston from the second race to prevent the transmission.

16. The 1-way clutch of claim 12 in which the second race includes;
a breakaway embodiment comprising;
a first rim, the first rim including keystone shaped extensions along its outer edge;
a second rim including keystone shaped extensions along its outer edge;
a peripheral band comprising sections; and
the sections including keystone shaped parts along both edges wherein the parts interlock with the extensions to prevent radial separation of the said embodiment.

17. The combination of claim 16 in which the embodiment includes an equivalent dowel wherein the dowel prevents radial separation of the embodiment.

18. The combination of claim 16 which includes;
a shaft supporting a first journal box and a second journal box;
at least one first spoke linking the said first rim to the first journal box;
at least one second spoke lining the said second rim to the second journal box; and
a first snap ring adjacent the said first journal box and a second snap ring adjacent the said second journal box wherein axial separation of the embodiment is prevented.
